(19) United States
(12) Patent Application Publication
(10) Pub. No.: US 2012/0308447 A1
(43) Pub. Date: Dec. 6, 2012

(54) TUBE AND FLOAT SYSTEMS FOR DENSITY-BASED FLUID SEPARATION

(76) Inventor: Timothy Alan Abrahamson, Seattle, WA (US)

(21) Appl. No.: 13/481,047

(22) Filed: May 25, 2012

Related U.S. Application Data
(60) Provisional application No. 61/491,533, filed on May 31, 2011.

(51) Int. Cl. B04B 15/00

(52) U.S. Cl. 422/548

(57) ABSTRACT

Tube and float systems that can be used to detect target materials in a suspension are disclosed. In one aspect, the tube includes structural elements along the inner surface of the tube and the float includes a smooth main body. The float is inserted into the tube along with the suspension and has a specific gravity to position the main body of the float at approximately the same level as the layer containing the target materials. The structural elements are configured so that when the tube, float, and suspension are centrifuged together, the structural elements form at least one channel between the main body of the float and the inner surface of the tube to allow the suspension fluid to flow around the float. Then centrifugation is stopped, the structural elements hold the float in place to enable detection of the target materials located in the at least one channels.

### CROSS-REFERENCE TO A RELATED APPLICATION

This application claims the benefit of Provisional Application 61/491,533, filed May 31, 2011.

### TECHNICAL FIELD

This disclosure relates generally to density-based fluid separation and, in particular, to tube and float systems for the separation and axial expansion of constituent suspension components layered by centrifugation.

### BACKGROUND

Suspensions often include materials of interests that are difficult to detect, extract and isolate for analysis because the materials occur with such low frequency. For example, blood is a suspension of various materials that is routinely examined for the presence of abnormal organisms or cells, such as circulating tumor cells (“CTCs”), fetal cells or ova, parasites, microorganisms, and inflammatory cells. Consider CTCs, which are of particular interest in the field of oncology because CTCs are cancer cells that have detached from a primary tumor, circulate in the bloodstream, and may be regarded as seeds for subsequent growth of additional tumors (i.e., metastasis) in other tissues. As a result, detecting, enumerating, and characterizing CTCs may provide valuable information in monitoring and treating cancer patients. Although detecting CTCs may help clinicians and cancer researchers predict a patient's chances of survival and/or monitor a patient's response to cancer therapy, CTC numbers are typically very small and are not easily detected. For instance, a 7.5 ml sample of peripheral whole blood that contains as few as 5 CTCs is considered clinically relevant in the diagnosis and treatment of a cancer patient. Practitioners, researchers, and those who work with suspensions seek systems and methods to detect, extract and isolate various kinds of materials of a suspension.

### SUMMARY

Tube and float systems that can be used to detect target materials in a suspension are disclosed. In one aspect, the tube includes raised structural elements located along the inner surface of the tube and the float includes a smooth main body outer surface. The suspension may be composed of various materials, including the target materials, that when centrifuged in the tube separate into different layers along the axial length of the tube according to the specific gravities of the materials. The float is configured with a specific gravity to position the main body of the float at approximately the same level as the layer containing the target materials. When the tube, float, and suspension are centrifuged together, the structural elements form at least one channel between the main body of the float and the inner surface of the tube to allow the suspension fluid to flow around the float. When centrifugation is stopped, the structural elements engage the outer surface of the float to hold the float in place and enable detection, extraction, and isolation of the target materials located in at least one channel.

### BRIEF DESCRIPTION OF THE DRAWINGS

FIGS. 1A-1B show isometric view of two example tube and float systems.

FIGS. 2A-2C show isometric views of three example floats.

FIGS. 3A-3E show examples of ridge cross-sectional shapes.

FIG. 4 shows a cross-sectional view of the system shown in FIG. 1, along a line A-A.

FIGS. 5A-5C show examples of different types of tube structural elements.

FIG. 6 shows an isometric view of an example tube and float system.

FIG. 7A shows an example of a tube and float system filled with a sample of anticoagulated whole blood.

FIG. 7B shows an example of the tube and float system shown in FIG. 7A with the float positioned to spread a buffy coat between layers of packed red blood cells and plasma.

### DETAILED DESCRIPTION

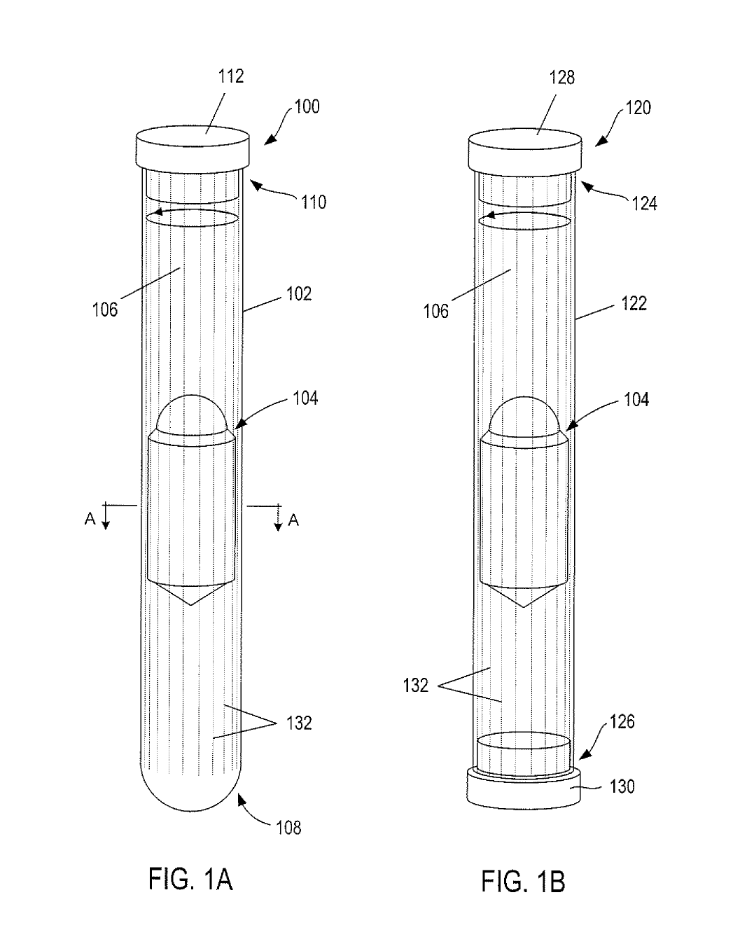

FIG. 1A shows an isometric view of an example tube and float system 100. The system 100 includes a tube 102 and a float 104, with the float 104 suspended in a suspension 106. In FIG. 1A, the tube 102 has a circular cross-section, a closed end 108, and an open end 110. The open end 110 is configured to receive a stopper or cap 112. FIG. 1B shows an isometric view of an example tube and float system 120. The system 120 is similar to the system 100 except the tube 102 is replaced by a tube 122 with two open ends 124 and 126 to receive the caps 128 and 130, respectively. The tubes 102 and 122 have a generally cylindrical geometry, but may also have a tapered geometry that widens toward the open ends 110 and 124, respectively. Although the tubes 102 and 122 have a circular cross-section, in other embodiments, the tubes 102 and 122 can have elliptical, square, triangular, rectangular, octagonal, or any other suitable cross-sectional shape that substantially extends the length of the tube. The example tubes 102 and 122 also include a number of raised structural elements in the form of raised, radially-spaced, axially-oriented ridges 132 located on the inner surfaces of the tubes 102 and 122. In the examples of FIGS. 1A and 1B, the ridges 132 span the length of the tubes 102 and 122 and are described in greater detail below. The tubes 102 and 122 can be composed of a transparent or semitransparent flexible material, such as plastic.

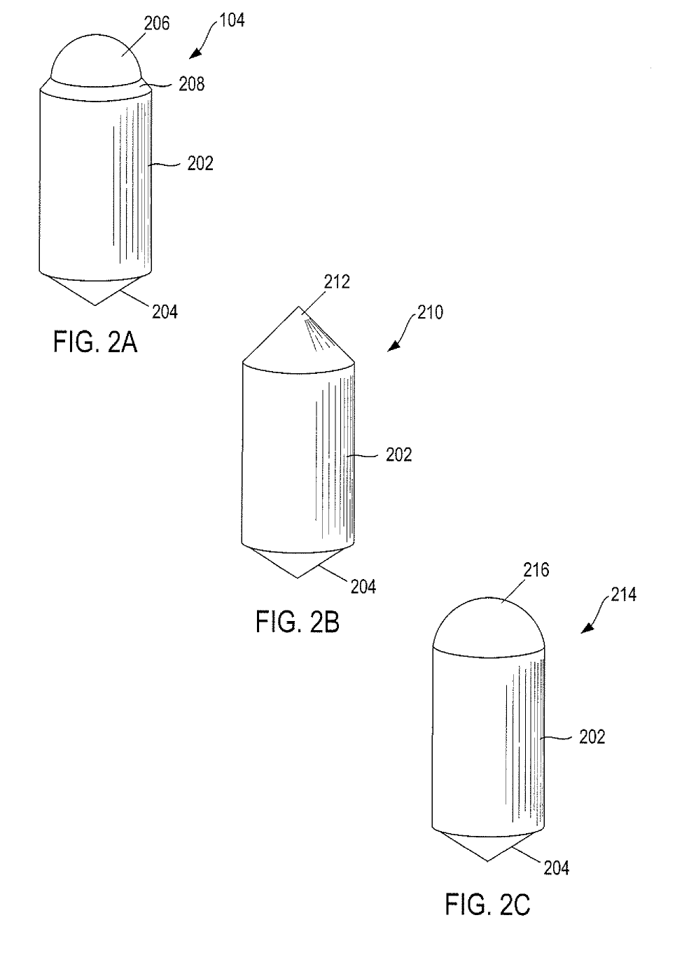

FIG. 2A shows an isometric view of the float 104 shown in FIG. 1. The float 104 includes a substantially smooth, cylindrical-shaped main body 202, a cone-shaped tapered end 204, and a dome-shaped end 206 with a tapered ring 208. Although the float 104 has a circular cross-section, in other embodiments, the float 104 can have elliptical, square, triangular, rectangular, octagonal, or any other suitable cross-sectional shape to substantially match the cross-sectional shape of the tube. Embodiments include other types of geometric shapes for float end caps, including a teardrop shape, and various combinations of differently shaped end caps. FIG. 2B shows an isometric view of an example float 210 with two cone-shaped end caps 212 and 204. FIG. 2C shows an isometric view of an example float 214 with the cone-shaped tapered end 204 and a dome-shaped end 216. A float can also include two dome-shaped or two teardrop-shaped end caps.

A float can be composed of a variety of different materials including, but are not limited to, metal, magnetic material, rigid organic or inorganic materials, and rigid plastic materials. Examples of rigid plastic materials include polyoxymethylene (“Delrin®”), polystyrene, acrylonitrile butadiene styrene (“ABS”) copolymers, aromatic polycarbonates, aromatic polyesters, carboxymethylcellulose, ethyl cellulose, ethylene vinyl acetate copolymers, nylon, polyacetals, polyacetates, polyacrylonitrile and other nitrile resins, polyacrylonitrile-vinyl chloride copolymer, polyamides, aromatic polyamides (“aramids”), polyamide-imide, polyarylates, polyarylene oxides, polyarylene sulfides, polyarylsulfones, polybenzimidazole, polybutylene terephthalate, polycarbonates, polyester, polyester imides, polyether sulfones, polyetherimides, polyetherketones, polyetheretherketones, polyethylene terephthalate, polyimides, polymethacrylate, polyolefins (e.g., polyethylene, polypropylene), polyallomers, polyoxadiazole, polyparaxylene, polyphenylene oxides (PPO), modified PPOs, polystyrene, polysulfone, fluorine containing polymer such as polytetrafluoroethylene, polyurethane, polyvinyl acetate, polyvinyl alcohol, polyvinyl halides such as polyvinyl chloride, polyvinyl chloride-vinyl acetate copolymer, polyvinyl pyrrolidone, polyvinylidene chloride, specialty polymers, polystyrene, polycarbonate, polypropylene, acrylonitrile butadiene-styrene copolymer and others.

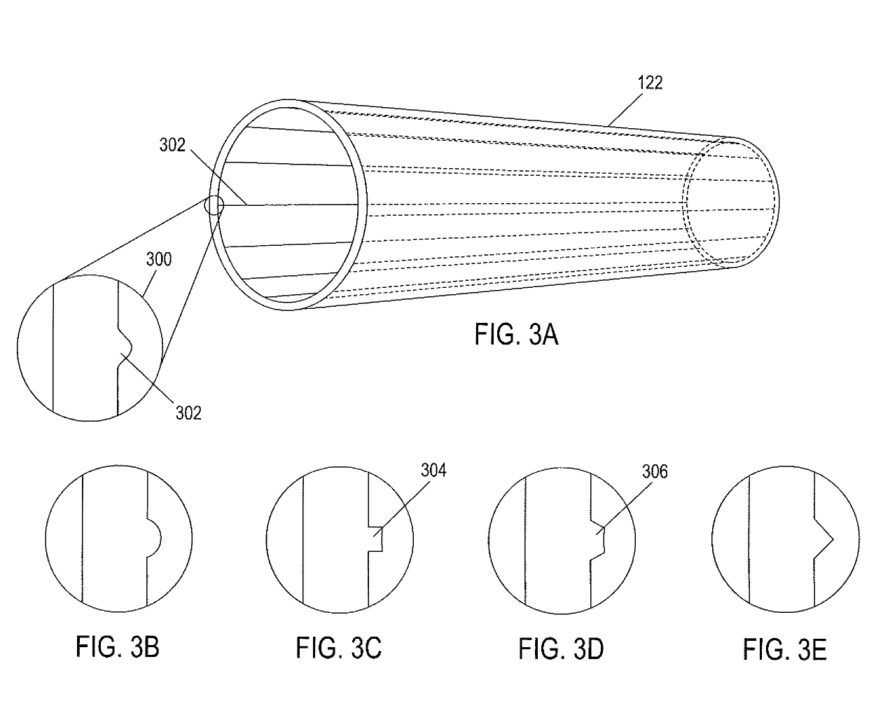

As described above with reference to FIGS. 1A and 1B, the tubes 102 and 122 include raised, radially-spaced, axially-oriented ridges 132 that approximately span the length of the tubes 102 and 122. The raised ridges 132 engage the smooth main body surface 202 of the float 104 to hold the float 104 in place when centrifugation is finished. FIG. 3A shows a perspective view of the tube 122 and includes an enlarged cross-sectional view 300 of a ridge 302. The ridge 302 has a raised smoothly varying cross-sectional shape that approximately spans the length of the tube 122. FIGS. 3B-3E show examples of four other types of ridge cross-sectional shapes. FIG. 3B shows a ridge with a semi-circular cross-sectional shape; FIG. 3C shows a ridge with a rectangular cross-sectional shape; FIG. 3D shows a ridge with a trapezoidal cross-sectional shape; and FIG. 3F shows a ridge with a triangular cross-sectional shape. In the examples of FIGS. 3C and 3D, the outer surfaces of the ridges 304 and 306 are curved to approximately match the curvature of the main body of the float. The number of ridges, ridge spacing, and ridge thickness are ridge parameters that can each be independently varied.

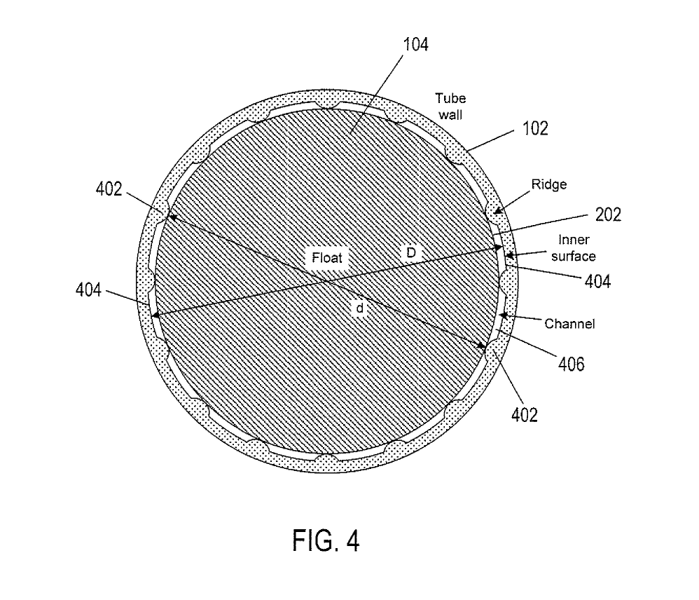

FIG. 4 shows a cross-sectional view of the system 100 along a section line A-A, shown in FIG. 1A. In the example of FIG. 4 the tube 102 has ridges 402 with semicircular cross-sectional shapes. The tube 102 has two inner diameters. The first inner surface diameter, D, is the distance through the center of the tube 102 between opposing inner surfaces 404. The second inner diameter, d, is the distance through the center of the tube 102 between opposing ridges 402. FIG. 4 reveals that the diameter of the main body 202 of the float 104 is approximately the same as or may be slightly larger than the second inner diameter d and is less than the inner surface diameter D of the tube 102, thereby defining channels 406 between the main body 202 and the inner surfaces 404 of the tube 102. The main body 202 occupies much of the cross-sectional area of the tube 102 with the channels 406 sized to contain a target material. The size of the channels 406 are determined by the distance between adjacent ridges and the distance between the main body 202 of the float 104 and the inner surfaces 404 of the tube 102. The channels 406 allow suspension fluid to flow between the inner surface of the tube 102 and the main body 202 of the float 104. The ridges 402 may also provide a support structure for the tube 102 and the height of the ridges 402 can be selected to adjust the focal length of a camera lens used to capture images of the contents of the channels through the tube 102 wall. However, in alternative embodiments, the ridges 402 can be discontinuous or segmented with one or more openings to allow the suspension to flow between the channels 406. The surfaces of the inner surfaces 402 between the ridges 132 can be curved, as shown in FIG. 4, flat, or have another suitable shape.

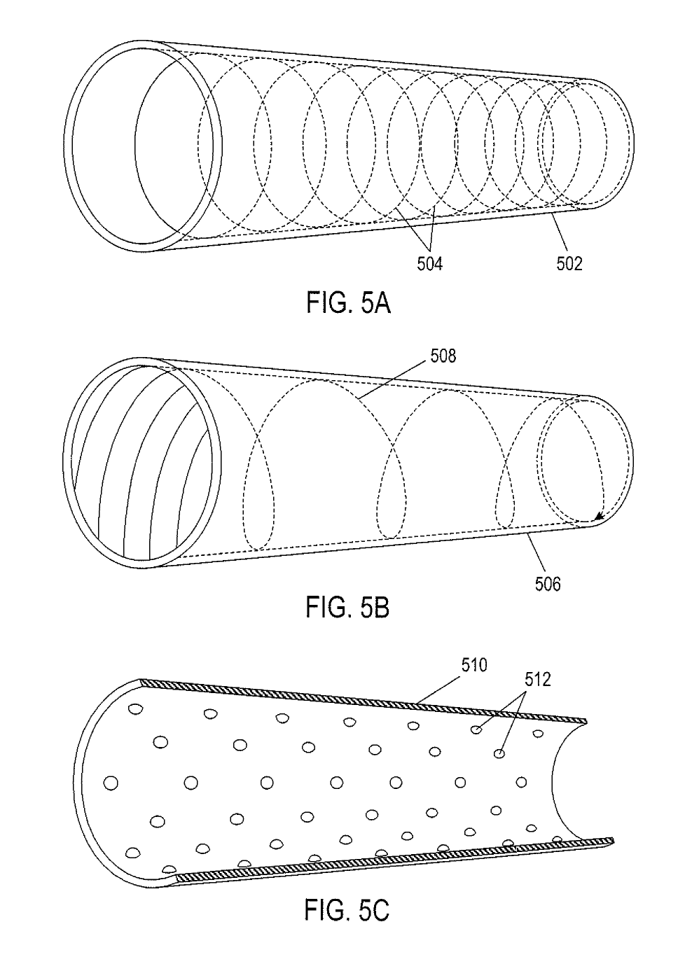

In other embodiments, the inner surface of the tube can include a variety of different raised structural elements for separating target materials, supporting the tube surface, holding the float in position when centrifugation is stopped, or directing the suspension fluid around the float during centrifugation. FIGS. 5A-5C show examples of three different types of raised structural elements. System embodiments are not intended to be limited to these three examples. In FIG. 5A, a tube 502 includes a series of regularly spaced, raised, circular ridges 504 located on the inner surface of the tube 502. The ridges 504 create annular-shaped channels between the main body 202 of the float 104 and the inner surface of the tube 504. The number of circular ribs, rib spacing, and rib thickness are parameters that can each be independently varied. In FIG. 5B, a tube 506 includes a number of continuous raised helical ridges that spiral around the inner surface of the tube 506. For the sake of simplicity of illustration, only one helical ridge 508 is shown as spanning the length of the tube 506. The helical ridges 508 create helical channels between the main body 202 of the float 104 and the inner surface of the tube 506. In other embodiments, the ridges can be broken or segmented to allow fluid to flow between adjacent turns of the channels. In various embodiments, the helical ridge spacing and ridge thickness are parameters that can be independently varied. FIG. 5C shows a cut-away of a tube 510 to reveal a number of protrusions 512 to create channels between the main body 202 of the float 104 and the inner surface of the tube 510.

The float 104 a desired specific gravity selected to position the main body 202 of the float at approximately the same level as the layer containing the target materials when the float, tube, and suspension are centrifuged together. By locating the raised structural features along the inner surface of the tube and not on the main body outer surface of the float, the potential for variation in the specific gravity of the float that would otherwise result from fabricating the float with structural elements is reduded. In addition, locating the raised structural elements on the inner surface of the tube eliminates having to manufacture the float with specific, ridge requirements, height requirements, thereby reducing the manufacturing cost of the float.

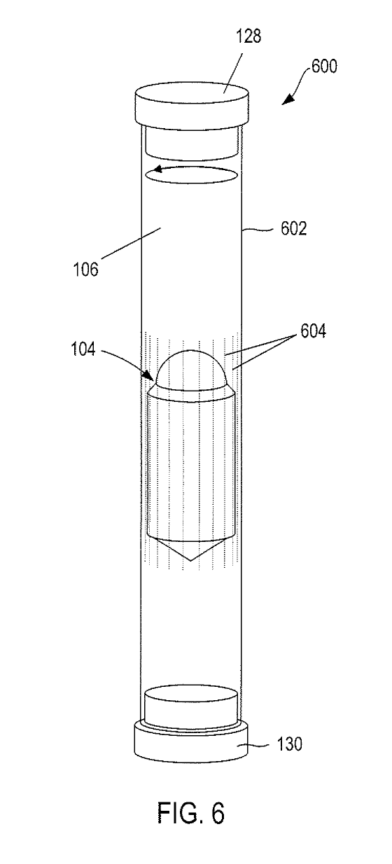

The raised structural elements do not have to span the length of the tube. Alternatively, the structural elements can be located in a region of the tube where the float is expected to come to rest as a result of centrifugation. FIG. 6 shows an example tube and float system 600. The system 600 is similar to the system 120 shown in FIG. 1B except the tube 122 of the system 120 has been replaced by a tube 602 with radially spaced and axial oriented ridges 604 located along the inner surface of the tube 602 and spanning a region of the tube where the float is expected to come to rest as a result of centrifugation. Alternatively, the axially oriented ridges 604 can be replaced with a series of circular ridges, helical ridges, or protrusions as described above with reference to FIG. 5.

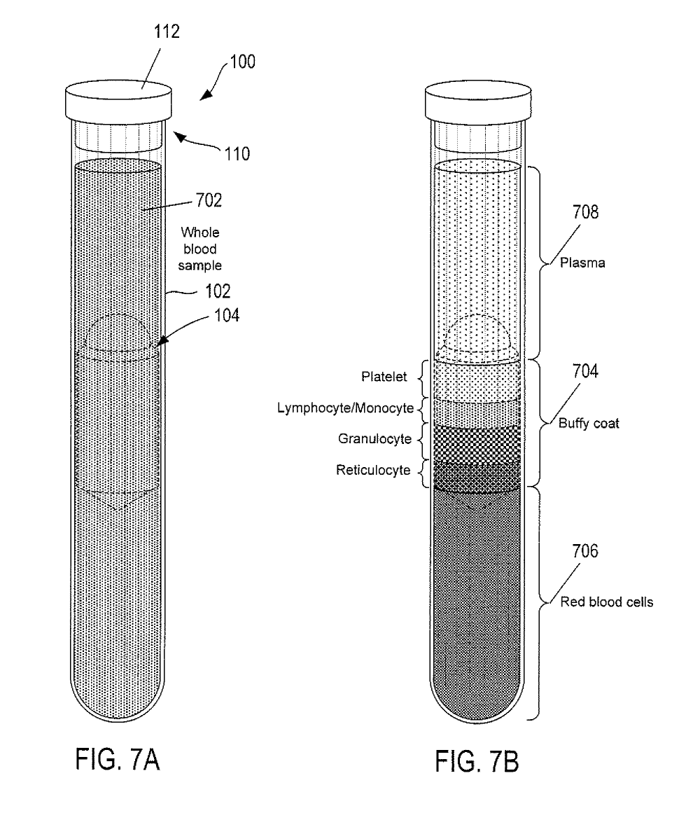

The tube and float systems described above can be used to expand the buffy coat of whole blood samples during centrifugation. FIG. 7A shows an example of the tube and float system 100 filled with a sample of anticoagulated whole blood 702. The sample 702 can be drawn into the tube 102 using venepuncture. Prior to drawing the sample 702 into the tube 102, the float 104 is selected with a specific gravity that positions the float 104 at approximately the same level as the buffy coat. The float 104 can then be inserted into the tube 122 followed by drawing the sample 702 into the tube 102, or the float 104 can be inserted after the sample 702 has been placed the tube 102. In the example shown in FIG. 7A, the cap 112 is inserted into the open end 110 of the tube 102. Next, the tube 102, float 104, and sample 702 are centrifuged for a period of time sufficient to separate the particles suspended in the sample 702 according to their specific gravities. FIG. 7B shows an example of the tube and float system 100 where the float 104 spreads a buffy coat 704 between a layer of packed red blood cells 706 and plasma 708. In the example of FIG. 7B, the centrifuged blood sample is composed of six layers: (1) packed red cells 706, (2) reticulocytes, (3) granulocytes, (4) lymphocytes/monocytes, (5) platelets, and (6) plasma 708. The reticulocyte, granulocyte, lymphocytes/monocyte, platelet layers form the buffy coat 704 and are the layers often analyzed to detect, extract, and isolate certain abnormalities, such as CTCs. In FIG. 7B, the float 104 expands the buffy coat, enabling the buffy coat 704 to be analyzed through the tube 102 surface. Any CTC's that lie within the buffy coat 704 fluid are located within retention channels between the float 104 main body 202 outer surface and the inner surface of the tube 102.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. They are not intended to be exhaustive of or to limit this disclosure to the precise forms described. Obviously, many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the following claims and their equivalents:

1. A tube and float system comprising:
a float with a substantially smooth main body outer surface; and
a tube having an inner surface with raised structural elements located on the inner surface, the raised structural elements to form at least one channel between the main body outer surface of the float and the inner surface of the tube to direct a suspension fluid around the float when the float, tube, and suspension are centrifuged together.

2. The system of claim 1, wherein the raised structural elements are configured to engage the main body of the float to hold the float in position when centrifugation is stopped.

3. The system of claim 1, wherein the at least one channel is defined by the distance between adjacent structural elements and the distance between the main body of the float and the inner surface of the tube.

4. The system of claim 1, wherein the raised structural elements span the approximate length of the tube.

5. The system of claim 1, wherein the raised structure elements are located in a region of the tube where the float is to come to rest when the float, tube, and suspension are centrifuged together.

6. The system of claim 1, wherein the raised structural elements further comprise raised, radially-spaced, axially-oriented ridges.

7. The system of claim 1, wherein the raised structural elements further comprise raised helical ridges that spiral around in the inner surface of the tube.

8. The system of claim 1, wherein the raised structural elements further comprise raised, regularly spaced, circular ridges.

9. The system of claim 1, wherein the raised structural elements further comprise a plurality of protrusions.

10. The system of claim 1, wherein the raised structural elements further comprise ridges having a smoothly varying cross-section.

11. The system of claim 1, wherein the raised structural elements further comprise ridges having a semi-circular cross-section.

12. The system of claim 1, wherein the raised structural elements further comprise ridges having a triangular cross-section.

13. The system of claim 1, wherein the raised structural elements further comprise ridges having a trapezoidal cross-section.

14. The system of claim 1, wherein the raised structural elements further comprise ridges having a rectangular cross-section.
